(19) United States
(12) Patent Application Publication
(10) Pub. No.: US 2014/0147040 A1
(43) Pub. Date: May 29, 2014

(54) IMAGE ENCODING DEVICE, IMAGE DECODING DEVICE, IMAGE ENCODING METHOD, AND IMAGE DECODING METHOD

(71) Applicant: KABUSHIKI KAISHA TOSHIBA, Tokyo (JP)

(72) Inventors: Tatsuya TANAKA, Kanagawa (JP); Atsushi MATSUMURA, Kanagawa (JP); Masato SUMIYOSHI, Kanagawa (JP); Keiri NAKANISHI, Kanagawa (JP); Masashi JOBASHI, Kanagawa (JP); Sho KODAMA, Kanagawa (JP)

(73) Assignee: KABUSHIKI KAISHA TOSHIBA, Tokyo (JP)

(21) Appl. No.: 14/045,222

(22) Filed: Oct. 3, 2013

(30) Foreign Application Priority Data
Nov. 28, 2012 (JP) 2012-259978

(51) Int. Cl. G06T 9/00

(52) U.S. Cl. CPC G06T 9/00
USPC 382/166

(57) ABSTRACT

According to an embodiment, an image encoding device includes a deciding unit, an assigning unit, and an encoding unit. The deciding unit is configured to determine representative colors for expressing each of pixel blocks into which image data are divided. The assigning unit is configured to assign an index for identifying the representative color to each pixel in the pixel block. The encoding unit is configured to encode indices and the representative colors, the indices and the representative colors in each pixel box being arranged alternately so that two representative colors are discontinuously encoded.

### CROSS-REFERENCE TO RELATED APPLICATION

This application is based upon and claims the benefit of priority from Japanese Patent Application No. 2012-259978, filed on Nov. 28, 2012; the entire contents of which are incorporated herein by reference.

### FIELD

Embodiments described herein relate generally to an image encoding device, an image decoding device, an image encoding method, and an image decoding method.

### BACKGROUND

A method for encoding an image using a plurality of representative colors is known as a technology for encoding image data. In this encoding method, image data to be encoded are divided into a plurality of regions, and indices for identifying representative colors as colors used in the image depending on pixels are assigned to all the pixels in the regions. The representative colors associated with the indices and the indices assigned to the respective pixels are then output as encoded data.

Furthermore, in the related art, the encoded data store representative colors associated with all the pixels at the beginning thereof followed by the indices associated with all the pixels.

In a conventional system, however, in the decoding side where the encoded data are decoded, the indices assigned to the respective pixels are obtained only after all the representative colors associated with all the pixels stored at the beginning of the encoded data are received. Thus, there may occur a time delay from reception of the encoded data to output of decoded data and the throughput per unit time may be lowered.

### BRIEF DESCRIPTION OF THE DRAWINGS

FIG. 1 is a block diagram of an image encoding device;

FIG. 2 is a schematic diagram illustrating pixel blocks;

FIG. 3 is a schematic diagram illustrating an example of representative colors;

FIG. 4 is a schematic diagram illustrating a result of index assignment;

FIG. 5 is a flowchart illustrating procedures of an encoding process;

FIG. 6 is a schematic diagram illustrating a data structure of encoded data;

FIG. 7 is a flowchart illustrating procedures of an encoding process;

FIG. 8 illustrates index encoding;

FIG. 9 is a flowchart illustrating procedures of an index encoding process;

FIG. 10 illustrates index assignment;

FIG. 11 illustrates a state after reassignment of indices;

FIG. 12 is a block diagram illustrating a functional configuration of an encoding unit;

FIG. 13 is a flowchart illustrating procedures of an encoding process;

FIG. 14 is a schematic diagram illustrating an example of representative colors;

FIG. 15 is a schematic diagram illustrating an example of a data structure of encoded data;

FIG. 16 illustrates predictive coding of representative colors;

FIG. 17 is a block diagram of an image encoding device;

FIG. 18 is a flowchart illustrating procedures of an encoding process;

FIG. 19 is a schematic diagram illustrating a data structure of encoded data;

FIG. 20 is a schematic diagram of a data structure of encoded data;

FIG. 21 is a schematic diagram of a functional configuration of an image decoding device;

FIG. 22 is a flowchart illustrating procedures of a decoding process;

FIG. 23 is a schematic diagram of a functional configuration of an image decoding device; and

FIG. 24 is a flowchart illustrating procedures of a decoding process.

### DETAILED DESCRIPTION

According to an embodiment, an image encoding device includes a deciding unit, an assigning unit, and an encoding unit. The deciding unit is configured to determine representative colors for expressing each of pixel blocks into which image data are divided. The assigning unit is configured to assign an index for identifying the representative color to each pixel in the pixel block. The encoding unit is configured to encode indices and the representative colors, the indices and the representative colors in each pixel box being arranged alternately so that two representative colors are discontinuously encoded.

### First Embodiment

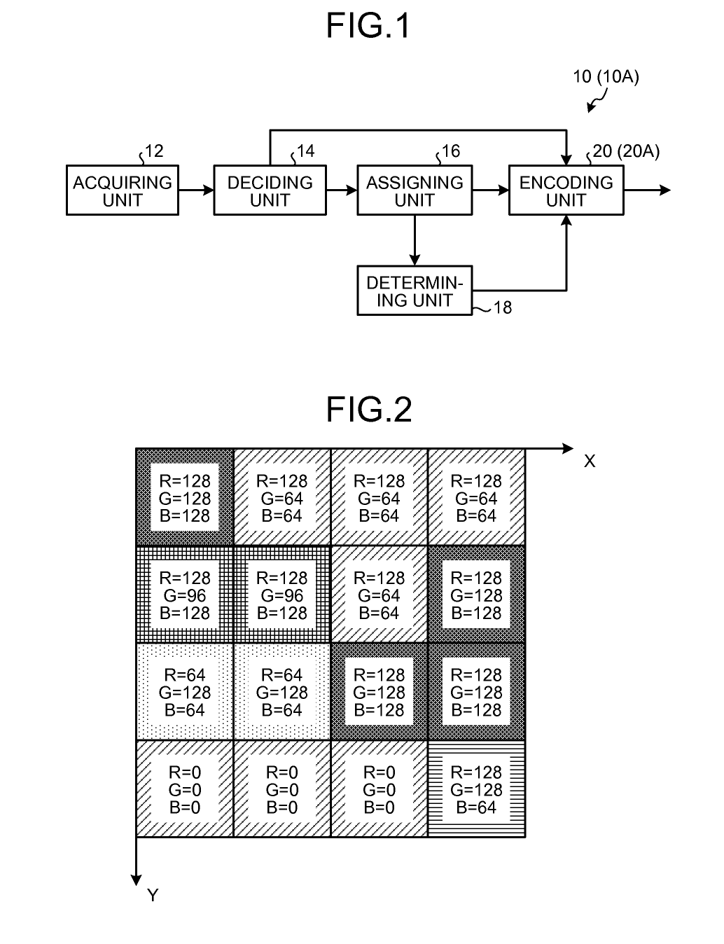

FIG. 1 is a block diagram illustrating a functional configuration of an image encoding device 10 according to the present embodiment. The image encoding device 10 is a device that performs image encoding. The image encoding device 10 is embedded in a device or system that mainly handles computer graphic (CG) images such as screens of a personal computer (PC), for example.

The image encoding device 10 according to the present embodiment includes an acquiring unit 12, a deciding unit 14, an assigning unit 16, a determining unit 18, and an encoding unit 20.

The acquiring unit 12 acquires image data to be encoded and divides the image data into pixel blocks of a predetermined size.

FIG. 2 is a schematic diagram illustrating an example of the pixel blocks. As illustrated in FIG. 2, the acquiring unit 12 divides the image data to be encoded into pixel blocks of 4×4 pixels, for example.

The unit of the pixel blocks into which the image data are divided by the acquiring unit 12 is not limited to pixel blocks of 4×4 pixels. For example, the acquiring unit 12 may divide the image data to be encoded into square pixel blocks of N×N pixels or into rectangle pixel blocks of N×M pixels. N and M are integers equal to or larger than 2, and are of different values. The acquiring unit 12 may also divide pixels to be encoded into pixel blocks of N×1 pixels or 1×N pixels in a form of lines.

Note that the acquiring unit 12 scans the pixels contained in the image data to be encoded in a known scan order such as raster scan, and divides the scanned image data into pixel blocks. The scan order in which the acquiring unit 12 scans the image data for dividing the image data into pixel blocks is not limited to raster scan.

In the present embodiment, description will be made on the assumption that colors of pixels contained in the image data to be encoded are expressed by the RGB color system. Note that the colors of the pixels are not limited to those of the RGB color system. For example, the colors of the pixels may be expressed by a color system other than the RGB color system such as YUV, YCbCr, or HSV. Furthermore, the description will be made on the assumption that the dynamic ranges of the colors of the pixels are expressed by 8 bits (0 to 255) in the present embodiment, but the dynamic ranges are not limited to 8 bits.

The description refers back to FIG. 1, where the deciding unit 14 sequentially receives the pixel blocks from the acquiring unit 12. The deciding unit 14 then determines one or more representative colors for expressing each of the received pixel blocks.

Specifically, the deciding unit 14 determines one or more representative colors depending on the pixel blocks for each pixel block. Note that, in the following description, the number of representative colors to be determined for each pixel block by the deciding unit 14 may be referred to as the representative color number.

The deciding unit 14 determines the representative colors according to a known method. In the present embodiment, the deciding unit 14 determines the representative colors, the number of representative colors being based on color values of the pixels in each pixel block.

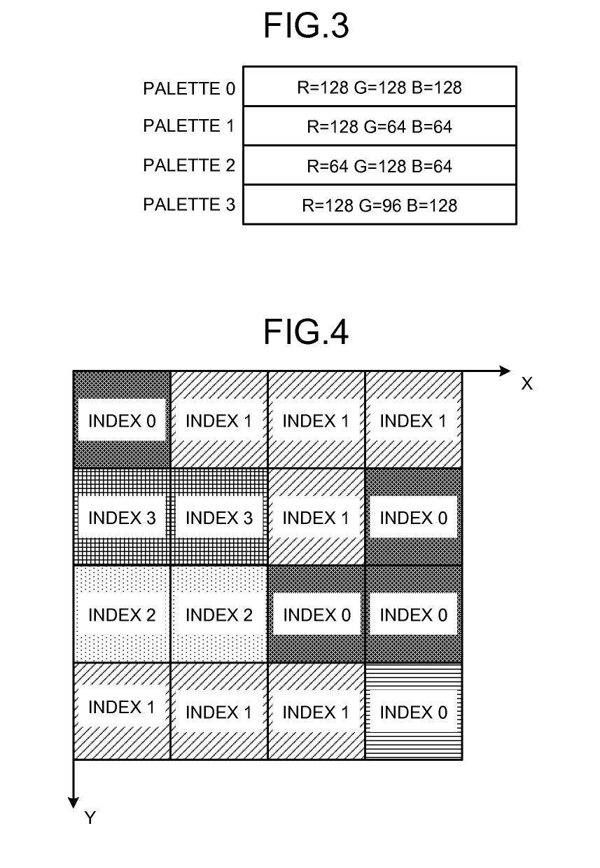

FIG. 3 is a schematic diagram illustrating an example of the representative colors determined by the deciding unit 14. As illustrated in FIG. 3, the deciding unit 14 determines four representative colors (palettes 0 to 3), for example. Note that the deciding unit 14 determines values expressed by the RGB color system, that is, color values of R, G, and B as the color values of the representative colors.

The deciding unit 14 may determine the representative colors by using a known method, and the determination method is not limited to that described above. For example, the deciding unit 14 may generate a histogram of colors of pixels contained in each pixel block, and determine the representative colors, the number of representative colors being based on the color distribution determined by the histogram. Alternatively, the deciding unit 14 may determine the representative colors by reading a preset number of representative colors. Still alternatively, the deciding unit 14 may adjust the number of representative colors according to the colors of pixels contained in each pixel block.

In a case where the deciding unit 14 determines a preset number of representative colors, it is not necessary to encode the determined number of representative colors at the encoding unit 20, which will be described later.

The description refers back to FIG. 1, where the assigning unit 16 assigns indices for identifying the respective representative colors, the number of representative colors being determined by the deciding unit 14, for each of pixels in a pixel block so that a pixel and an index are in one-to-one relationship. An index is identification information for uniquely identifying each representative color, and is expressed by a number or the like that represents a representative color, for example.

Specifically, the assigning unit 16 calculates the distances between the color values of each of the pixels in a pixel block and the color values of the representative colors determined by the deciding unit 14 in a color space, and assigns to the pixel an index for identifying a representative color with the smallest calculated distance.

The following Equation (1) is used as a formula for calculating the distance between the color values of each pixel and the color values of a representative color.

$$Distance = α \times \vert ( R of pixel to be encoded ) - ( R of representative color ) \vert + β \times \vert ( G of pixel to be encoded ) - ( G of representative color ) \vert + γ \times \vert ( B of pixel to be encoded ) - ( B of representative color ) \vert \qquad ( 1 )$$

In Equation (1), “R of pixel to be encoded” represents the color value of R of a pixel to be encoded. “R of representative color” represents the color value of R of a representative color determined by the deciding unit 14. “G of pixel to be encoded” represents the color value of G of the pixel to be encoded. “G of representative color” represents the color value of G of the representative color determined by the deciding unit 14. “B of pixel to be encoded” represents the color value of B of the pixel to be encoded. “B of representative color” represents the color value of B of the representative color determined by the deciding unit 14.

In addition, in Equation (1), α is a weighting factor on R (the color value of R). In Equation (1), β is a weighting factor on G (the color value of G), and γ is a weighting factor on B (the color value of B). A case in which α=β=γ=1 is satisfied will be described in the present embodiment.

Although the case in which α=β=γ=1 is satisfied will be described in the present embodiment, the values of α, β, and γ are not limited thereto. For example, α=γ=1 and β=2 may be satisfied when priority is given to G (the color value of G) taking the Bayer array into consideration. In a case of the YUV color system, when a weighting factor on Y (the color value of Y) is α, a weighting factor on U (the color value of U) is β, and a weighting factor on V (the color value of V) is γ, α=2 and β=γ=1 may be satisfied so that priority is given to Y.

Furthermore, lower bits may be omitted, for example, without obtaining the differences with the accuracy of 8 bits. In other words, the number of bits may be reduced like an arithmetic right shift. As a result of calculating the differences after reducing the number of bits from 8 to 7, the number of bits will be back to 8 even information of 1 bit is added as information on positive or negative, and it is thus not necessary to increase the number of bits to be processed.

Note that the method for assigning indices by the assigning unit 16 is not limited to the method described above. For example, the assigning unit 16 may use an equation other than Equation (1) as the formula for calculating the distance between the color values of each pixel and the color values of a representative color. Furthermore, the assigning unit 16 may assign the indices by a known method allowing indices of the same values to be likely to be assigned to adjacent pixels so that encoding of indices by the encoding unit 20, which will be described later, will be facilitated.

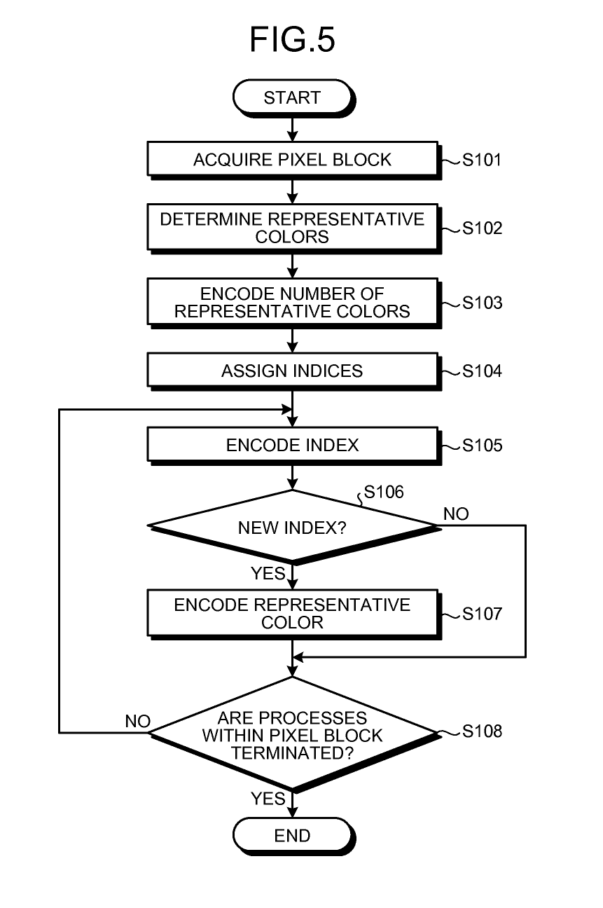

FIG. 4 is a schematic diagram illustrating an example of a result of assigning one of indices of four representative colors (palettes 0 to 3) illustrated in FIG. 3 to each of the pixels in the pixel block illustrated in FIG. 2.

As illustrated in FIG. 4, the assigning unit 16 assigns an index of a representative color to each pixel on the basis of the color values (RGB values) of each pixel in the pixel block and the color values of the representative colors decided by the deciding unit 14.

The description refers back to FIG. 1, where the determining unit 18 determines whether or not an index assigned to a pixel to be encoded is a new index when the encoding unit 20 scans the pixels constituting the pixel block in a predetermined scan order. Specifically, the determining unit 18 determines whether or not a pixel to which an index having a value different from those of encoded indices is scanned (that is, whether or not the pixel is to be encoded) in the pixel block while the pixels in the pixel block to be encoded are sequentially scanned and encoded so as to determine whether or not the index is a new index.

The encoding unit 20 receives the determination result from the determining unit 18. The encoding unit 20 also receives the determined representative colors from the deciding unit 14. Furthermore, the encoding unit 20 also receives the pixel block to which indices are assigned from the assigning unit 16.

The encoding unit 20 arranges and encodes the indices assigned to the respective pixels in the pixel block and the representative colors identified by the indices alternately according to the result of determination by the determining unit 18 so that two or more representative colors are not encoded successively.

Next, an encoding process performed by the image encoding device 10 will be described. FIG. 5 is a flowchart illustrating procedures of the encoding process performed by the image encoding device 10.

When image data to be encoded are acquired by the acquiring unit 12, the image encoding device 10 performs the encoding process.

First, the deciding unit 14 acquires a pixel block resulting from division by the acquiring unit 12 (step S101).

Subsequently, the deciding unit 14 determines representative colors according to the pixel block (step S102). As a result of the process of step S102, the deciding unit 14 determines the representative colors, the number representative colors being according to the pixel block to be encoded as described above.

Subsequently, the encoding unit 20 encodes the number of representative colors determined in step S102 (step S103).

Subsequently, the assigning unit 16 assigns the indices of the representative colors to the respective pixels in the pixel block acquired in step S101 (step S104).

Subsequently, the encoding unit 20 scans the pixels in the pixel block acquired in step S101 in a predetermined scan order to sequentially identify pixels to be encoded, and performs processes of steps S105 to S108 thereon.

Specifically, the encoding unit 20 performs an index encoding process of encoding an index assigned to a pixel to be encoded (step S105). For example, when an index is “0”, the encoding unit 20 encodes “0”.

Subsequently, the determining unit 18 determines whether or not the index encoded in the preceding process of step S105 is a new index (step S106). If the determination made by the determining unit 18 in step S106 is positive (step S106: Yes), the process proceeds to step S107. If, on the other hand, the determination in step S106 is negative (step S106: No), the process proceeds to step S108.

In step S107, the encoding unit 20 encodes the representative colors associated with the index encoded in step S105 (step S107). Specifically, the encoding unit 20 encodes the color values of the representative colors. For example, when the index encoded in step S105 is “0”, the encoding unit 20 encodes the color values “R=128, G=128, B=128” of the representative colors “palette 0” associated with the index “0” (also see FIG. 3).

Subsequently, the encoding unit 20 determines whether or not the processes of steps S105 to S107 are performed on all the pixels contained in the pixel block acquired in step S101 (step S108). If the determination in step S108 is negative (step S108: No), the process returns to step S105 described above. If, on the other hand, the determination in step S108 is positive (step S108: Yes), this routine is terminated.

The image encoding device 10 performs the processes in steps S101 to S108 described above on all the pixel blocks of the image data to be encoded. In this manner, the image data to be encoded are encoded.

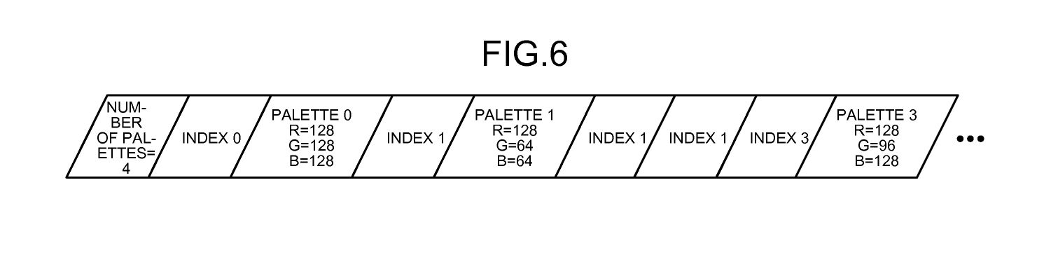

FIG. 6 is a schematic diagram illustrating an example of the data structure of the encoded data generated by the encoding process in the image encoding device 10.

Note that FIG. 6 is a schematic diagram illustrating the data structure of part of the encoded data generated by the encoding unit 20 in a case where the deciding unit 14 determines the representative colors illustrated in FIG. 3 and the assigning unit 16 assigns indices illustrated in FIG. 4 to the pixels in a pixel block.

As a result of performing the encoding process described above, the encoded data have a structure in which indices and representative colors identified by the indices are alternately arranged so that two or more representative colors are not successively arranged as illustrated in FIG. 6.

Specifically, at the beginning of the encoded data, the number of representative colors (see “palette number=4 in FIG. 6) that is encoded is arranged as illustrated in FIG. 6. Then, for an index (new index) that first appears in the pixel block to be encoded, an encoded representative color (specifically, the color values of the representative color) identified by the index is arranged after the index. For an index that has already appeared in the pixel block to be encoded, only the index is encoded and the representative color associated with the index is not encoded.

Thus, the encoded data generated by the image encoding device 10 have a structure in which indices and representative colors identified by the indices are alternately arranged so that two or more representative colors are not successively arranged.

As described above, the image encoding device 10 according to the present embodiment arranges and encodes indices and representative colors identified by the indices alternately so that two or more representative colors are not successively arranged.

With the image encoding device 10 according to the present embodiment, it is thus possible to generate encoded data on which a decoding process can be started before receiving all the representative colors contained in the encoded data. With the image encoding device 10 according to the present embodiment, it is thus possible to shorten the time delay from reception of encoded data to output of decoded data at a decoding device that decodes the encoded data.

With the image encoding device 10 according to the present embodiment, it is therefore possible to improve the throughput per unit time in decoding the encoded data.

Modification 1-1

Note that, in the process of encoding pixels in a pixel block, the assigning unit 16 may assign a predetermined index to a pixel to be encoded first. For example, the assigning unit 16 may assign an index “0” to the pixel to be encoded first among the pixels constituting the pixel block.

In this manner, it is not necessary to assign an index to the pixel to be encoded first among the pixels constituting the pixel block. As a result, the number of encoded indices contained in the encoded data will be a number obtained by subtracting 1 from the number of pixels constituting the pixel block. It is thus possible to reduce the data amount of the encoded data.

Modification 1-2

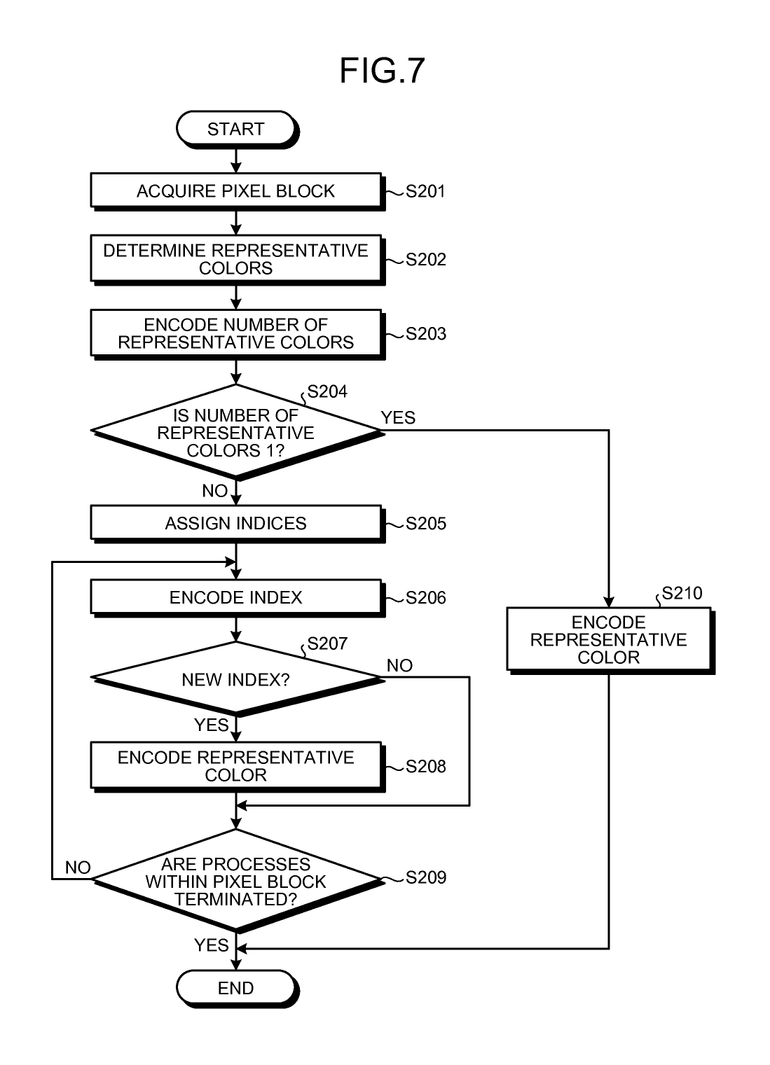

Furthermore, when the number of representative colors determined by the deciding unit 14 for a pixel block to be encoded is “1”, the encoding unit 20 may not encode the index information of the pixel block. In this case the image encoding device 10 only needs to perform an encoding process illustrated in FIG. 7.

FIG. 7 is a flowchart illustrating procedures of the encoding process according to the modification.

As illustrated in FIG. 7, the deciding unit 14 first acquires a pixel block resulting from division by the acquiring unit 12 (step S201). Subsequently, the deciding unit 14 determines representative colors according to the pixel block (step S202). Subsequently, the encoding unit 20 encodes the number of representative colors determined in step S202 (step S203). The processes of step S201 to S203 are the same as those of steps S101 to S103 in the first embodiment described above.

Subsequently, the encoding unit 20 determines whether or not the number of representative colors determined in step S202 is “1” (step S204). If the determination in step S204 is positive (step S204: Yes), the process proceeds to step S210.

In step S210, the encoding unit 20 encodes only one representative color determined in step S202 (step S210), and this routine is terminated.

If, on the other hand, the determination in step S204 is negative (step S204: No), the process proceeds to step S205. In steps S205 to S209, the same processes as those of step S104 to S108 in the first embodiment are performed. Then, the processes of steps S201 to S210 are then performed for a next unprocessed pixel block in the image to be encoded.

As described above, with the image encoding device 10 according to the present modification, the processes of steps S205 to S209 including assignment of indices and encoding of indices are not performed when the number of representative colors determined for a pixel block to be encoded is “1”, that is, when there is only one representative color.

As a result, with the image encoding device 10 according to the present modification, it is further possible to reduce the amount of operation in the encoding process and to reduce the data amount of the generated encoded data in addition to the effects of the first embodiment.

Modification 1-3

In the embodiment described above, the description has been made on the assumption that the encoding unit 20 encodes the whole information in fixed-length codes. The encoding unit 20, however, may perform encoding using a code length according to the type of data to be encoded.

For example, the encoding unit 20 may change the code length according to the frequency of appearance of indices of the same value in a pixel block to be encoded in encoding the indices. In other words, the encoding unit 20 may perform encoding by using variable-length coding. Examples of the variable-length coding include Huffman coding and arithmetic coding. Alternatively, the encoding unit 20 may perform encoding using run-length encoding that collectively encodes successive indices.

Modification 1-4

Furthermore, in the embodiment described above, the case where the encoding unit 20 encodes indices assigned to the respective pixels has been described. The encoding unit 20, however, may encode an index of a pixel to be encoded by using encoded pixels adjacent to the pixel to be encoded in encoding of indices.

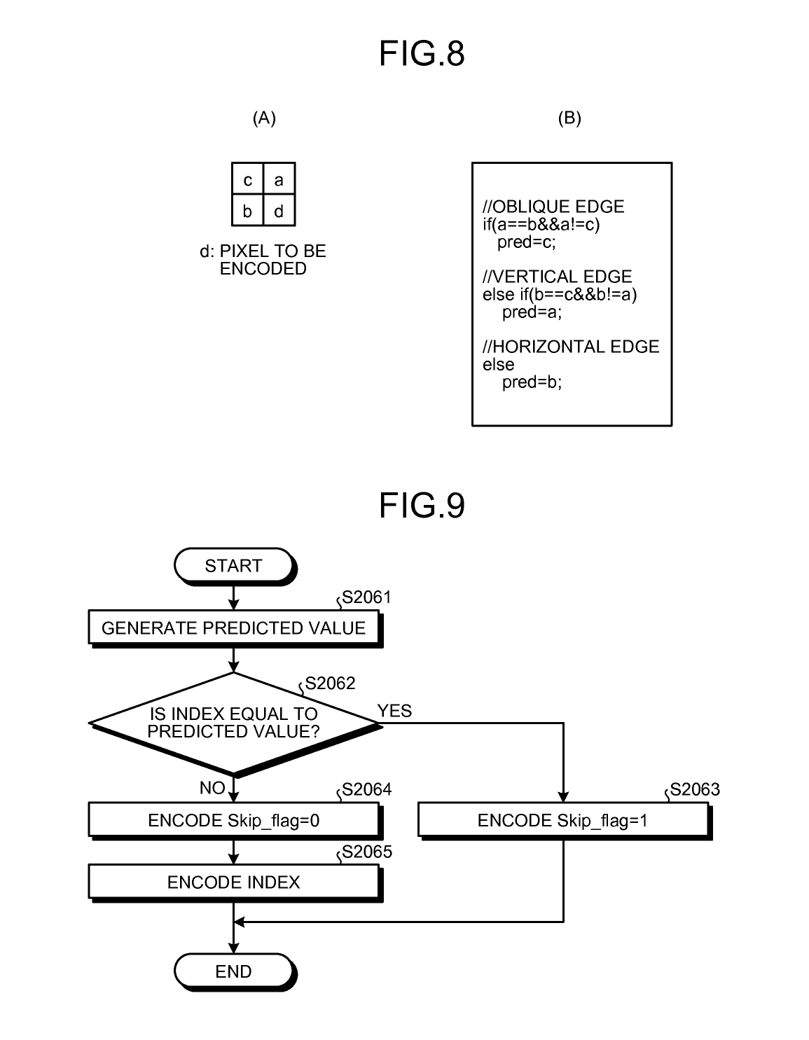

FIG. 8 illustrates a method by which the encoding unit 20 encodes an index by using encoded pixels adjacent to a pixel to be encoded.

Note that a, b, and c in FIG. 8 represent encoded pixels. Furthermore, d in FIG. 8 represents a pixel to be encoded.

In addition, procedures of an index encoding process performed by the encoding unit 20 in the state of (A) of FIG. 8 will be described with reference to FIG. 9. FIG. 9 is a flowchart illustrating the procedures of the index encoding process performed by the encoding unit 20 in the present modification. Note that the index encoding process illustrated in FIG. 9 is performed in place of the index encoding process in step S206 (see FIG. 7) in the modification 1-2.

First, for encoding an index of a pixel to be encoded, the encoding unit 20 generates a predicted value of the index of the pixel to be encoded from the indices of encoded pixels adjacent to the pixel to be encoded (step S2061).

Specifically, for encoding the index of d that is a pixel to be encoded in (A) of FIG. 8, the encoding unit 20 predicts the index of d from the indices of a, b, and c that are pixels adjacent to d and encoded. For example, when the indices of the pixels a and b are equal and the indices of the pixels a and c are different, the encoding unit 20 determines that a diagonal edge is present in the image and generates c as the predicted value (pred) (see (B) of FIG. 8).

Similarly, when the indices of b and c are equal and the indices of b and a are different in (A) of FIG. 8, the encoding unit 20 determines that a vertical edge is present in the image and generates a as the predicted value (pred) (see (B) of FIG. 8). In cases other than above, the encoding unit 20 determines that a horizontal edge is present and generates b as the predicted value (pred) (see (B) of FIG. 8).

Note that the method for determining the predicted value may be a known method, and is not limited to the above method.

Subsequently, the encoding unit 20 determines whether or not the predicted value generated in step S2061 is coincident with the index of d (step S2062). If the determination in step S2062 is positive (step S2062: Yes), the process proceeds to step S2063. In step S2063, the encoding unit 20 encodes information indicating Skip_flag=1 with 1 bit (step S2063). This routine is then terminated.

If, on the other hand, the determination in step S2062 is negative (step S2062: No), the process proceeds to step S2064. The encoding unit 20 then encodes information indicating Skip_flag=0 (step S2064), and further encodes the index of d in fixed-length codes, for example (step S2065). This routine is then terminated.

As described above, according to the present modification, the index of a pixel to be encoded is encoded by using indices of encoded pixels adjacent to the pixel to be encoded. As a result, in a case of an image where correlation between indices of adjacent pixels is high, it is only needed to encode 1-bit flag instead of encoding an index with a fixed-length of 2 bits.

According to the present modification, it is thus possible to generate encoded data with a high compression ratio in addition to the effects of the first embodiment.

Modification 1-5

Note that the encoding unit 20 may encode indices by using variable-length coding.

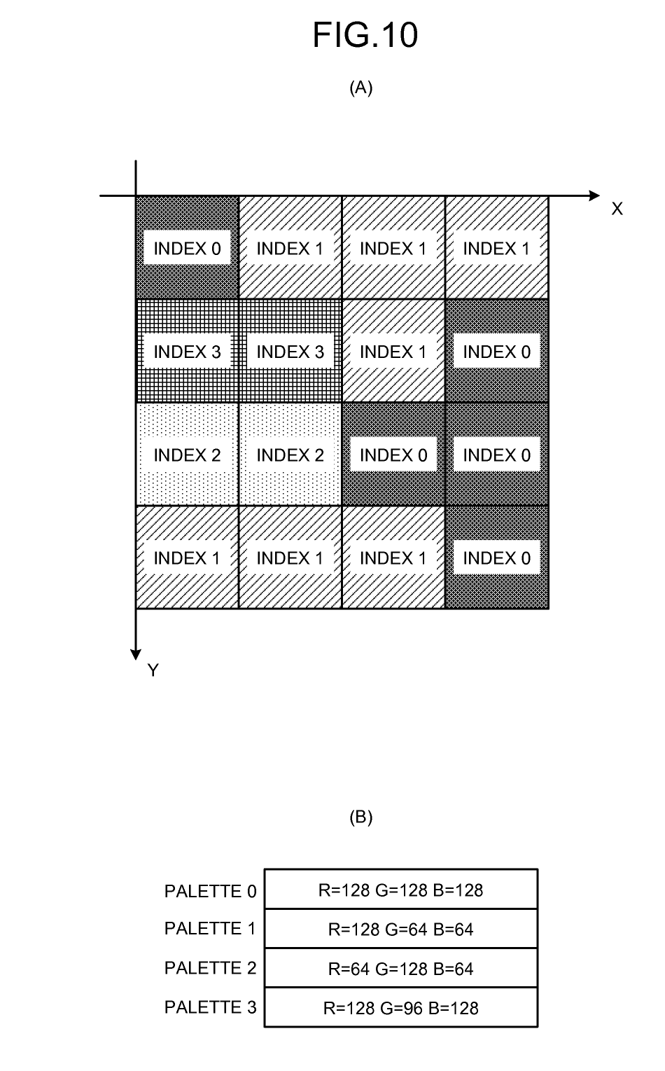

FIG. 10 illustrates index assignment. For example, it is assumed that a pixel block to be encoded is the one illustrated in FIG. 2. It is also assumed that the deciding unit 14 determines four representative colors (palettes 0 to 3) illustrated in (B) of FIG. 10 for the pixel block to be encoded.

In this case, the deciding unit 14 assigns indices illustrated in (A) of FIG. 10, for example, to pixels in the pixel block to be encoded. As a result of scanning the pixels in this pixel block in a predetermined scan order for encoding by the encoding unit 20, the timings at which the values of indices associated with the representative values newly appear will be in the order of “index 0”, “index 1”, “index 3”, and “index 2”.

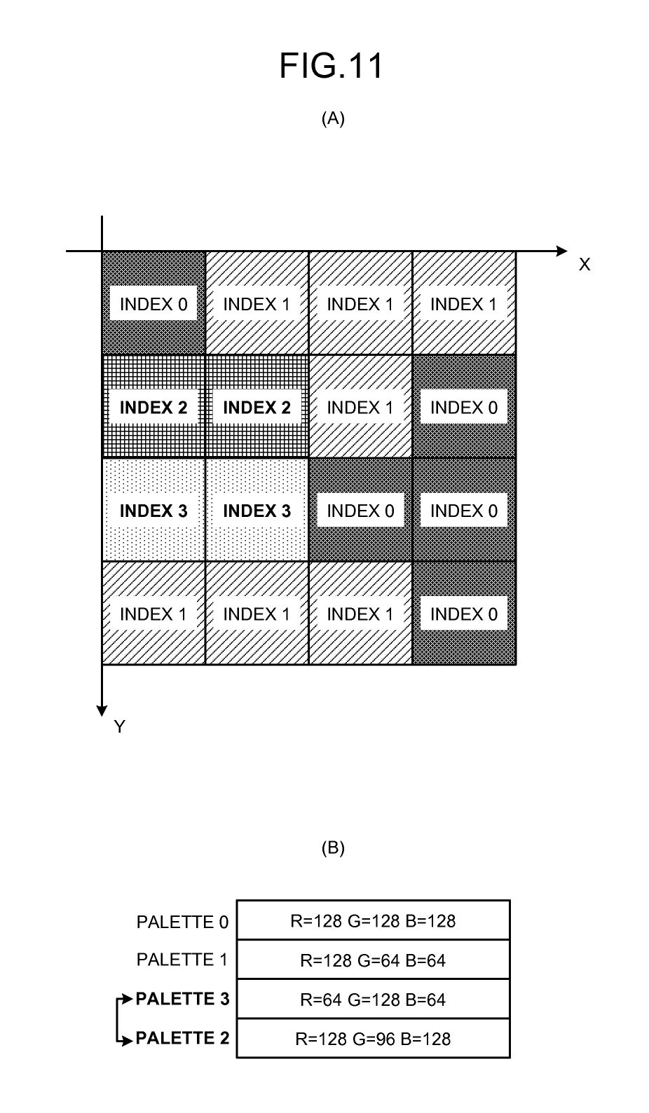

FIG. 11 illustrates a state after reassignment of indices. In this case, the encoding unit 20 reassigns the indices so that the indices will be arranged in the ascending order according to the scan order like “index 0” to “index 3” (see FIG. 11).

Specifically, the encoding unit 20 changes the association between the representative colors and the indices associated with the representative colors so that the indices assigned to the pixels constituting the pixel block to be encoded are arranged in ascending order according to the scan order for sequentially encoding the pixels.

In the example illustrated in FIG. 11, an index “palette 2” associated with the representative color expressed by the color values “R=64, G=128, B=64” is changed to an index “palette 3”. Furthermore, an index “palette 3” associated with the representative color expressed by the color values “R=128, G=96, B=128) is changed to “palette 2” (see FIG. 11B). As a result, the indices to be assigned to the pixels in the pixel block are assigned in ascending order according to the scan order for encoding the pixels constituting the pixel block as illustrated in (A) of FIG. 11.

Note that the encoding unit 20 may perform the reassignment process after performing the process of assigning the indices to the pixels as illustrated in step S104 of FIG. 5. Then, the encoding unit 20 may further scan the pixels in the pixel block in a predetermined scan order after performing this reassignment process and perform the processes of steps S105 to S108 described with reference to FIG. 5.

In this manner, as a result of reassigning the indices, no indices having a value that is larger than (the maximum value of indices appearing so far)+1 will appear at a time point when the encoding unit 20 has scanned the pixels to be encoded. It is thus possible to control the code length of indices according to the appearance of indices.

For example, at a time point when the encoding unit 20 has encoded an index of the 0-th pixel, only “index 0” has appeared. Thus, it is guaranteed that the index of the 1-st pixel will be “index 0” or “index 1”. It is therefore possible to express the index, which is originally encoded with 2 bits, with information of 1 bit indicating “index 0” or “index 1”.

According to the present modification, it is therefore possible to generate encoded data with a higher compression ratio than a case where indices are encoded in fixed-length codes in addition to the effects of the first embodiment.

Modification 1-6

Note that, in encoding a representative color (see step S107 in FIG. 5), the encoding unit 20 preferably quantizes the representative color. Specifically, encoding is preferably performed by quantizing the color values of the representative color. As a result of quantizing the representative color, it is possible to generate encoded data with a higher compression ratio.

For quantizing a representative color, there is a method of uniformly omitting the lower bits of the color values expressed by 8 bits so that the color values are expressed by 6 bits, for example. When the number of representative colors is four and the color values of R, G, and B are expressed by 8 bits, for example, 24 bits are required per one representative color. That is, 8 bits×three components of R, G, and B×four colors=96 bits are required.

When the lower bits of the color values expressed by 8 bits are uniformly omitted so that the color values are expressed by 6 bits, one representative color can be expressed by 18 bits. That is, this results in 72 bits (6 bits×three components (R, G, and B)×four colors=72 bits).

It is thus possible to generate encoded data with a higher compression ratio than a case where 8-bit information is encoded without any change.

Modification 1-7

Furthermore, in encoding a representative color (see step S107 in FIG. 5), the encoding unit 20 preferably determine the code length with which the representative color is encoded according to dynamic ranges of the color values of the representative color. As a result of appropriately changing the code length according to the dynamic ranges of the color values of the representative color, it is possible to generate encoded data with a higher compression ratio.

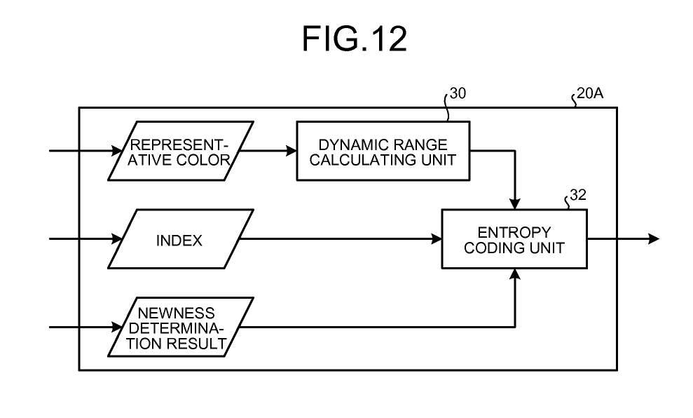

In this case, an image encoding device 10A in which the encoding unit 20 of the first embodiment is replaced by an encoding unit 20A illustrated in FIG. 12 (see FIG. 1) may be used. FIG. 12 is a block diagram illustrating the functional configuration of the encoding unit 20A.

The encoding unit 20A includes a dynamic range calculating unit 30 and an entropy coding unit 32.

The dynamic range calculating unit 30 calculates the dynamic ranges of the representative colors determined by the deciding unit 14. The entropy coding unit 32 performs entropy coding.

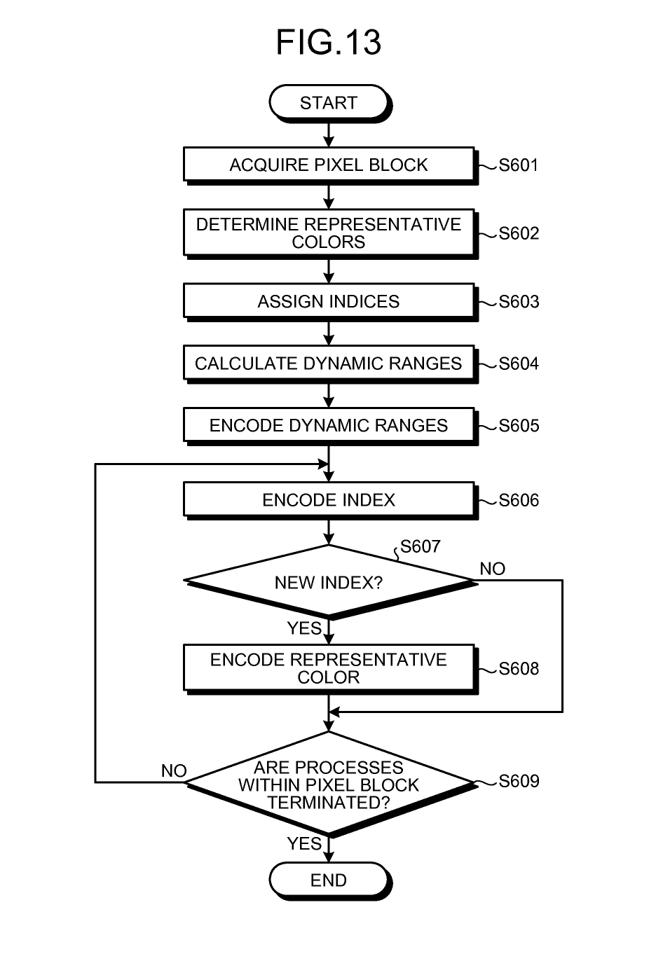

FIG. 13 is a flowchart illustrating procedures of an encoding process performed by the image encoding device 10A (see FIG. 1) including the encoding unit 20A in place of the encoding unit 20.

First, the image encoding device 10A performs the same processes as those in steps S101 to S102 and S104 of the image encoding device 10 according to the first embodiment (steps S601 to S603).

Subsequently, the dynamic range calculating unit 30 calculates the dynamic ranges of the representative colors determined by the deciding unit 14 for each of the R, G, and B components (step S604).

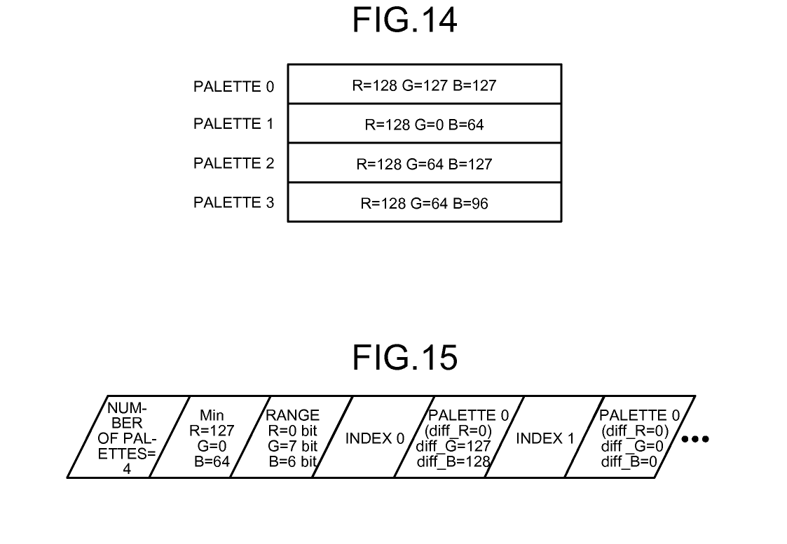

FIG. 14 is a schematic diagram illustrating an example of the representative colors determined by the deciding unit 14. In the example illustrated in FIG. 14, the deciding unit 14 determines the color values (RGB values) of four representative colors (“palette 0” to “palette 3”).

In this case, the dynamic range calculating unit 30 calculates [128, 128] for R, [0, 127] for G, and [64, 127] for B as the dynamic ranges of the R, G, and B components, respectively.

Subsequently, the entropy coding unit 32 encodes the dynamic ranges calculated in step S604 (step S605).

For example, the entropy coding unit 32 encodes the minimum values in the dynamic ranges of the R, G, and B components and the number of bits required for expressing the dynamic ranges of the R, G, and B components. The entropy coding unit 32 encodes [128] for R, [0] for G, and [64] for B, as a minimum value for example, in fixed-length (8-bit, for example) codes.

Furthermore, regarding the number of bits required for expressing the dynamic ranges of the representative colors, the entropy coding unit 32 only needs to express the section of [128, 128] for R. The required number of bits is therefore 0 bits (R_Range=0 bits). For G, 7 bits (G_Range=7 bits) are required for expressing the section [0, 127]. For B, 6 bits (B_Range=6 bits) are required for expressing the section [64, 127]. The entropy coding unit 32 then encodes information on the number of bits required for expressing these representative colors in fixed-length (4-bit, for example) codes.

Subsequently, the entropy coding unit 32 scans the pixels in the pixel block acquired in step S601 in a predetermined scan order, and performs the processes of steps S606 to S609 on each of the pixels.

Note that the processes in steps S606 and S607 are the same as those of steps S105 and S106 in the first embodiment (see FIG. 5).

In step S608, the entropy coding unit 32 encodes the representative color on the basis of the dynamic ranges calculated in step S604 described above (step S608).

In the present modification, the entropy coding unit 32 encodes differences between the color values of each representative color and the minimum values of the respective R, G, and B components.

An example in which a representative color “palette 0” in FIG. 14 is encoded will be described.

First, the entropy encoding unit 32 encodes a difference [0] obtained by subtracting the minimum value [128] of the R component calculated in step S604 from the value [128] of R in “palette 0” among the four representative colors (“palette 0” to “palette 3”) determined by the deciding unit 14. As described above, in the present modification, the number of bits required for R is 0 bits (R_Range=0 bits) as the number of bits required for expressing the dynamic ranges of a representative color. It is therefore not necessary to encode this difference.

The entropy encoding unit 32 also encodes a difference obtained by subtracting the minimum value [0] of the G component calculated in step S604 from the value [127] of G in “palette 0” among the four representative colors determined by the deciding unit 14. As described above, in the present modification, the number of bits required for G is 7 bits (G_Range=7 bits) as the number of bits required for expressing the dynamic ranges of a representative color. The entropy coding unit 32 thus encodes the difference [127] using 7 bits.

Similarly, the entropy encoding unit 32 also encodes a difference [63] obtained by subtracting the minimum value [64] of the B component calculated in step S604 from the value [127] of B in “palette 0” among the four representative colors determined by the deciding unit 14. As described above, in the present modification, the number of bits required for B is 6 bits (B_Range=6 bits) as the number of bits required for expressing the dynamic ranges of a representative color. The entropy coding unit 32 thus encodes the difference [63] using 6 bits.

FIG. 15 is a schematic diagram illustrating an example of the data structure of encoded data generated in the present modification.

As described above, 96 bits are required for encoding representative colors when the representative colors are encoded with a fixed length of 8 bits in the embodiment described above. In contrast, as a result of determining the code lengths for encoding the representative colors according to the dynamic ranges of the representative colors, encoded data having the data structure illustrated in FIG. 15 are obtained in the present modification. Specifically, as illustrated in FIG. 15, only 88 bits ((8+4) bits×three components (R, G, and B)+(0+7+6) bits×four colors=88 bits) are used for encoding the representative colors in the present modification.

According to the present modification, it is thus possible to generate encoded data with a high compression ratio in addition to the effects of the first embodiment.

Modification 1-8

Furthermore, the encoding unit 20 may predict a representative color for encoded pixels and encode the representative color.

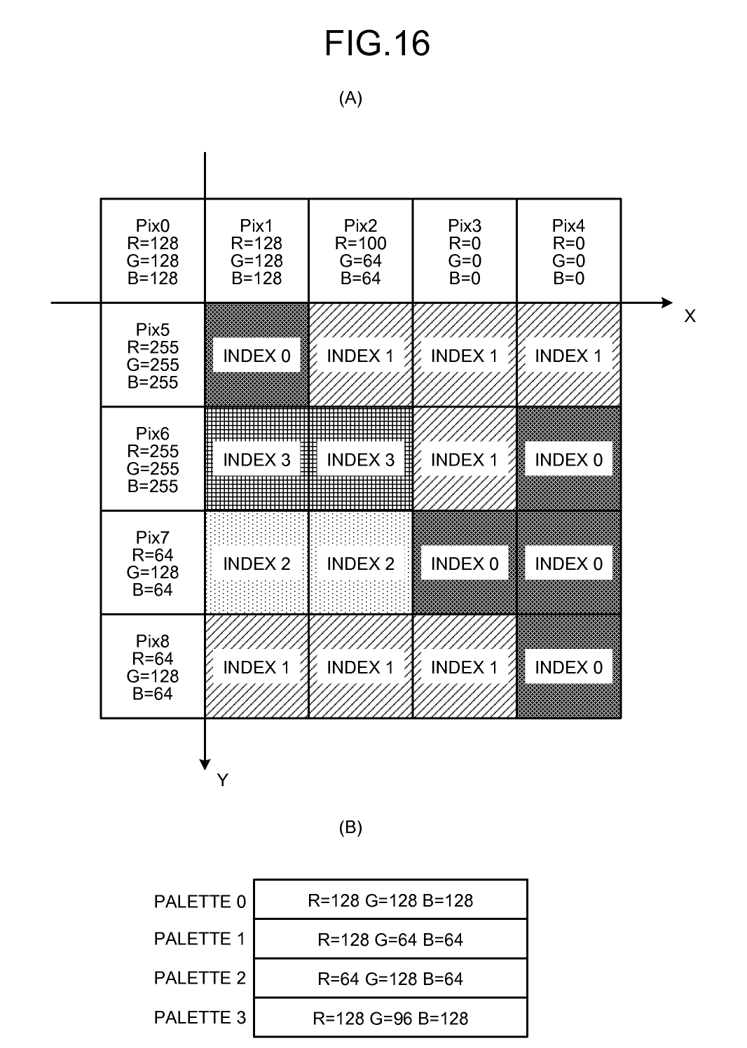

FIG. 16 illustrates explanatory diagrams of predictive coding of representative colors. Illustrated in (A) of FIG. 16 is an explanatory diagram of encoding representative colors using encoded pixels. Illustrated in (B) of FIG. 16 is a schematic diagram illustrating an example of the determined representative colors.

In (A) of FIG. 16, “Pix0” to “Pix8” represent encoded pixels. In addition, the description will be made on the assumption that the encoding unit 20 scans the pixels represented by “index” in (A) of FIG. 16 in the order of raster scan.

For example, it is assumed that the 0-th pixel is to be encoded by the encoding unit 20. In this case, the index (“index 0”) assigned to the 0-th pixel is a new index that newly appears at this time point. The encoding unit 20 thus encodes “index 0” and the representative color “palette 0” that is a representative color identified by this index.

In this process, the encoding unit 20 searches for an encoded pixel having the same color values as the representative color “palette 0” from “Pix0” to “Pix8”. In the example illustrated in FIG. 16, the color values of the representative color “palette 0” and “Pix1” are the same. Accordingly, the encoding unit 20 encodes the representative color “palette 0”, that is, a flag “Skip_palette=1” with 1 bit instead of the encoding process of encoding each of the R, G, and B values with 8 bits. In this process, the encoding unit 20 also encodes information indicating that the color values (also referred to as a pixel value) are the same as those of “Pix1”.

For information specifying “Pix1”, codes 0000(2) to 1000(2) are assigned to “Pix0” to “Pix8”, respectively, for example. Then, Pix1=0001(2) may be encoded with a fixed length of 4 bits. Note that the encoding unit 20 may encode a position (“X=0, Y=−1”, for example) relative to that of a pixel to be encoded.

Subsequently, the encoding unit 20 encodes the 1-st pixel. The index (“index 1”) assigned to the 1-st pixel is a new index that newly appears at this time point. Accordingly, the encoding unit 20 encodes this index (“index 1”) and the representative color (“palette 1”) identified by the “index 1”.

Similarly, in this case, the encoding unit 20 searches for an encoded pixel having the same color values as the representative color “palette 1” from “Pix0” to “Pix8”. In the example illustrated in (A) of FIG. 16, no encoded pixel having the same color values as the representative color “palette 1” is present. The encoding unit 20 thus encodes a flag “Skip_palette=0” with 1 bit and encodes each of the R, G, and B components of the representative color “palette 1” with 8 bits.

Although an encoded pixel having identical color values is searched for in the present modification, the method is not limited thereto. For example, the encoding unit 20 may define a threshold (referred to as a threshold B) for identifying color values to be the same in advance. The encoding unit 20 may then search for an encoded pixel where a sum of absolute differences between the color values thereof and the color values of the representative color identified by the index of the pixel to be encoded is equal to or smaller than the threshold B as the pixel having identical color values.

Furthermore, the encoding unit 20 may encode the R, G, and B components of a representative color by using a combination of the method of encoding after quantization and the method of encoding using dynamic ranges.

### Second Embodiment

In the first embodiment, the description has been made on the case in which the image encoding device 10 encodes a representative color identified by an index assigned to each of pixels in a pixel block to be encoded when it is determined that the index is a new index in encoding the pixels.

In the present embodiment, an image encoding device (an image encoding device 40 which will be described below in the present embodiment) encodes representative colors at timings different from those in the first embodiment.

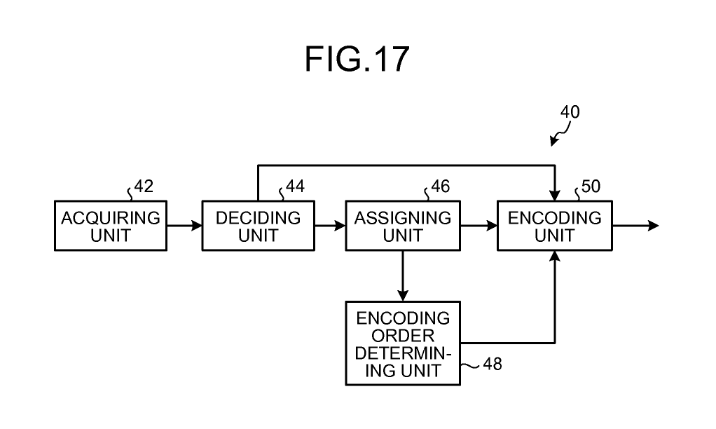

FIG. 17 is a block diagram illustrating the functional configuration of an image encoding device 40 according to the present embodiment. The image encoding device 40 includes an acquiring unit 42, a deciding unit 44, an assigning unit 46, an encoding order determining unit 48, and an encoding unit 50.

The acquiring unit 42, the deciding unit 44, the assigning unit 46, and the encoding unit 50 are the acquiring unit 12, the deciding unit 14, the assigning unit 16, and the encoding unit 20, respectively, in the first embodiment. The present embodiment differs from the first embodiment in that the encoding order determining unit 48 is included instead of the determining unit 18 in the image encoding device 10 according to the first embodiment.

The difference from the first embodiment will be described in detail below.

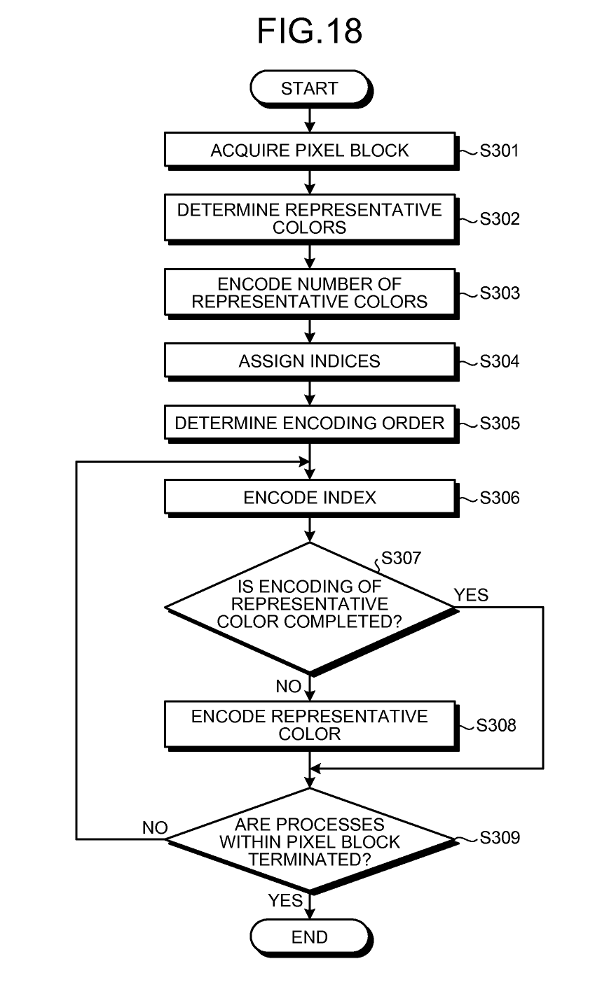

FIG. 18 is a flowchart illustrating procedures of an encoding process performed by the image encoding device 40 according to the present embodiment.

First, the deciding unit 44 acquires a pixel block resulting from division by the acquiring unit 42 (step S301). Subsequently, the deciding unit 44 determines representative colors according to the pixel block (step S302). Subsequently, the encoding unit 50 encodes the number of representative colors determined in step S302 (step S303). Subsequently, the assigning unit 46 assigns the indices of the representative colors to the respective pixels in the pixel block acquired in step S301 (step S304). The processes of step S301 to S304 are the same as those of steps S101 to S104 in the first embodiment.

Subsequently, the encoding order determining unit 48 determines an encoding order in which the representative colors are encoded on the basis of a result of assigning the indices by the process of step S304 (step S305).

In step S305, the encoding order determining unit 48 determines the encoding order to be the same as the order of timings at which the indices associated with the respective representative colors newly appear during encoding of the pixels in the pixel block.

A case in which the indices illustrated in FIG. 4 are assigned to the pixels in the pixel block to be encoded will be described here. As described in the first embodiment, FIG. 4 is a schematic diagram illustrating an example of a result of assigning one of indices of four representative colors (palettes 0 to 3) illustrated in FIG. 3 to each of the pixels in the pixel block illustrated in FIG. 2.

In this case, the encoding order determining unit 48 first scans the pixels in the pixel block to be encoded in a predetermined scan order. Similarly to the first embodiment, the present embodiment will also be described on the assumption that raster scan is performed.

First, when the encoding unit 50 encodes the 0-th pixel, “index 0” newly appears. Subsequently, when the 1-st pixel is encoded, “index 1” newly appears. Subsequent scan is performed in the same manner, and “index 3” newly appears at the 4-th pixel, and “index 2” newly appears in the 8-th pixel. Accordingly, in the pixel block to which the indices illustrated in FIG. 4 are assigned, the timings at which the indices newly appear during the raster scan performed by the encoding unit 50 are in the order of “index 0”, “index 1”, “index 3” and “index 2”.

In the present embodiment, the encoding order determining unit 48 determines an encoding order according to the timings (array) at which the indices newly appear at the pixels in the pixel block to be encoded as the encoding order of the representative colors identified by the indices. In the example described above, the encoding order determining unit 48 determines the array of the representative colors “palette 0”, “palette 1”, “palette 3”, and “palette 2” according to the order of “index 0”, “index 1”, “index 3”, and “index 2” as the encoding order of the representative colors.

Subsequently, the encoding unit 50 encodes the indices similarly to step S105 of the first embodiment (step S306). For example, the encoding unit 50 encodes the index (“index 0”) of the 0-th pixel.

Subsequently, the encoding unit 50 determines whether or not encoding of all the representative colors for which the encoding order is determined in step S305 is completed (step S307). If the determination in step S307 is negative (step S307: No), the process proceeds to step S308. If, on the other hand, the determination in step S307 is positive (step S307: Yes), the process proceeds to step S309.

In step S308, one unencoded representative color is encoded according to the encoding order determined in step S305 described above (step S308). In the present embodiment, the encoding unit 50 encodes a representative color “palette 0”, for example.

Subsequently, the encoding unit 50 determines whether or not the encoding process is completed for all the pixels contained in the pixel block to be encoded (step S309). If the determination in step S309 is positive (step S309: Yes), this routine is terminated.

If, on the other hand, the determination in step S309 is negative (step S309: No), the process returns to step S306 described above. The processes of steps S306 to S309 are then repeated until the determination in step S309 becomes positive (step S309: Yes).

For example, when the 0-th pixel is previously encoded, the encoding unit 50 subsequently sets the 1-st pixel as the pixel to be encoded. The encoding unit 50 then encodes the index (“index 1”) of the 1-st pixel and then encodes the next representative color (“palette 1”). Furthermore, the encoding unit 50 sets the 2-nd pixel as the pixel to be encoded. The encoding unit 50 then encodes the index (“index 1”) of the second pixel and then encodes the next representative color (“palette 3”). Furthermore, the encoding unit 50 then encodes the index (“index 1”) of the third pixel and then encodes the next representative color (“palette 2”).

At the time point when the encoding process on the 3-rd pixel is completed, encoding of all the representative colors for the pixel block to be encoded is completed, and the encoding unit 50 only encodes the indices without encoding the representative colors (step S307: Yes) in the encoding process on subsequent pixels in the pixel block.

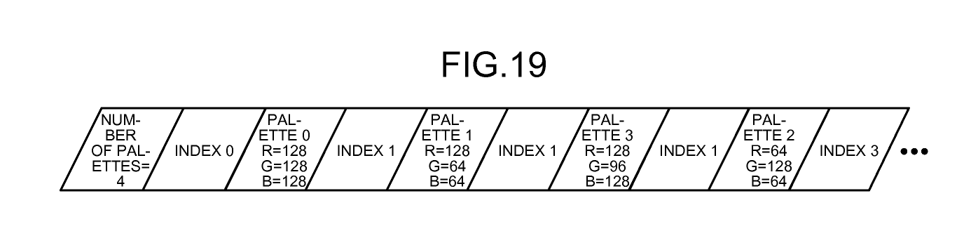

FIG. 19 is a schematic diagram illustrating an example of the data structure of the encoded data generated by the image encoding device 40 according to the present embodiment.

With the image encoding device 40 according to the present embodiment, representative colors identified by indices of the same value are encoded only once among representative colors identified by indices assigned to pixels in a pixel block to be encoded. Then, for pixels to which indices associated with encoded representative colors, only the indices are encoded.

As a result, with the image encoding device 40 according to the present embodiment, it is possible to simplify the encoding process in addition to the effects of the first embodiment.

Although the case in which encoding is performed in the order of an “index” and a “representative color” in the encoded data is described in the present embodiment, the order is not limited thereto. For example, encoding may be performed in the order of a “representative color” and an “index” in the encoded data.

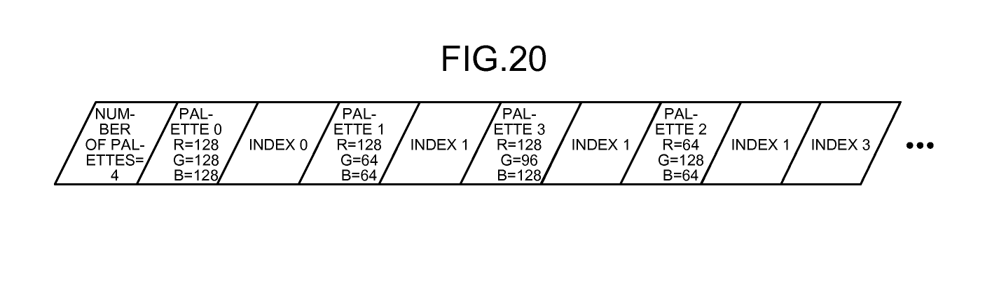

FIG. 20 is a schematic diagram illustrating an example of the data structure of encoded data generated by performing encoding in the order of a “representative color” and an “index”.

As illustrated in FIG. 20, the encoded data may have a structure in which the arrangement of an “index” and a “representative color” in FIG. 19 is reversed.

### Third Embodiment

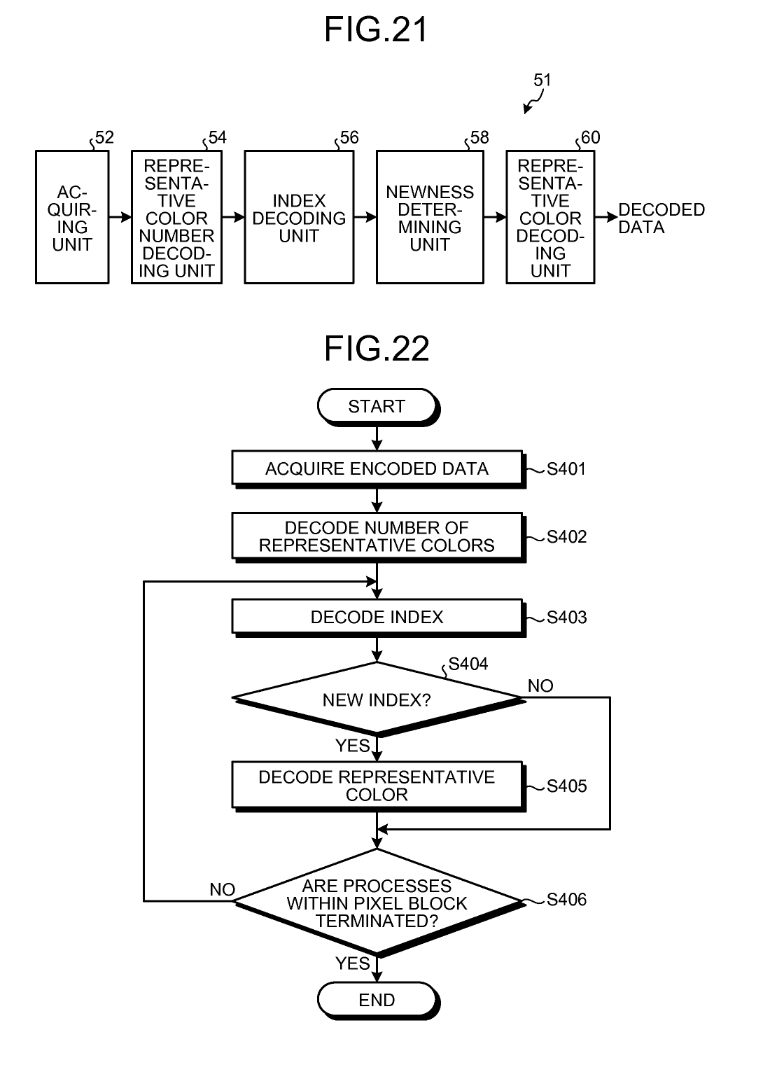

FIG. 21 is a schematic diagram of the functional configuration of an image decoding device 51 according to the present embodiment.

The image decoding device 51 decodes encoded data generated by the image encoding device 10 or the image encoding device 10A in the embodiments described above.

The image decoding device 51 includes an acquiring unit 52, a representative color number decoding unit 54, an index decoding unit 56, a newness determining unit 58, and a representative color decoding unit 60.

The acquiring unit 52 acquires encoded data from the image encoding device 10, for example.

The representative color number decoding unit 54 reads the encoded data acquired by the acquiring unit 52 from the beginning, and decodes the encoded number of representative colors contained in the encoded data. The index decoding unit 56 reads the encoded data acquired by the acquiring unit 52 from the beginning thereof and decodes encoded indices contained in the encoded data.

The newness determining unit 58 determines whether or not an index decoded by the index decoding unit 56 is an index that newly appears in the pixel block to be decoded (that is, a new index). The representative color decoding unit 60 decodes a representative color according to the result of determination by the newness determining unit 58.

Next, a decoding process performed by the image decoding device 51 will be described.

FIG. 22 is a flowchart illustrating procedures of the decoding process performed by the image decoding device 51.

First, the acquiring unit 52 acquires encoded data (step S401). Subsequently, the representative color number decoding unit 54 reads data from the beginning of the encoded data acquired in step S401 and decodes the number of representative colors (the number of palettes) arranged at the beginning of the encoded data (step S402).

When the encoded data acquired by the acquiring unit 52 in step S401 are encoded data in which the number of representative colors is a fixed value, the process of step S402 is not performed.

Subsequently, the image decoding device 51 performs the decoding process in steps S403 to S406 in encoding units used for the pixel block when the encoded data are obtained by encoding.

First, the index decoding unit 56 decodes an index of a pixel to be decoded (step S403). Subsequently, the newness determining unit 58 determines whether or not the index decoded in step S403 is a new index (step S404).

If the determination in step S404 is positive (step S404: Yes), the process proceeds to step S405. In step S405, the representative color decoding unit 60 decodes the representative color identified by the index decoded in step S403 (step S405). The process then proceeds to step S406.

If, on the other hand, the determination in step S404 is negative (step S404: No), the process proceeds to step S406.

In step S406, the index decoding unit 56 determines whether or not the decoding process is terminated for all the pixels in the pixel block to be decoded (step S406). If the determination in step S406 is negative (step S406: No), the process returns to step S403 described above. If, on the other hand, the determination in step S406 is positive (step S406: Yes), this routine is terminated.

The image decoding device 51 performs the processes of steps S403 to S406 in units of a pixel block.

As described above, the image decoding device 51 according to the present embodiment decodes encoded data obtained by arranging and encoding indices and representative colors identified by the indices alternately so that two or more representative colors are not successively arranged. The image decoding device 51 can thus start the decoding process before receiving all the representative colors contained in the encoded data.

With the image decoding device 51 according to the present embodiment, it is therefore possible to improve the throughput per unit time in decoding the encoded data.

### Fourth Embodiment

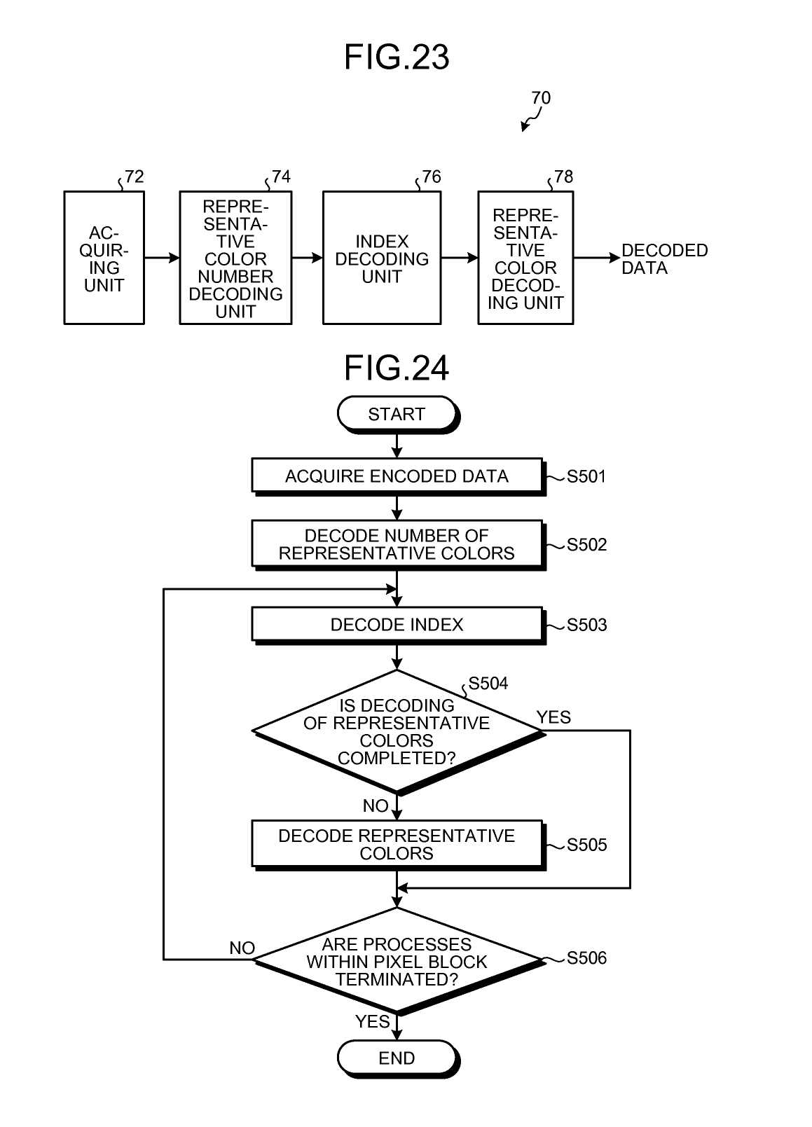

FIG. 23 is a schematic diagram of the functional configuration of an image decoding device 70 according to the present embodiment. The image decoding device 70 is a device that decodes encoded data generated by the image encoding device 40 according to the second embodiment. The image decoding device 70 decodes representative colors at timings different from those in the image decoding device 51 according to the third embodiment.

The image decoding device 70 includes an acquiring unit 72, a representative color number decoding unit 74, an index decoding unit 76, and a representative color decoding unit 78.

The acquiring unit 72 acquires encoded data from the image encoding device 10, for example. The representative color number decoding unit 74 reads the encoded data acquired by the acquiring unit 72 from the beginning, and decodes the number of representative colors contained in the encoded data. The index decoding unit 76 reads the encoded data from the beginning thereof and decodes indices contained in the encoded data. The representative color decoding unit 78 decodes the representative color.

FIG. 24 is a flowchart illustrating procedures of the decoding process performed by the image decoding device 70 according to the present embodiment.

First, the acquiring unit 72 acquires encoded data (step S501). Subsequently, the representative color number decoding unit 74 reads data from the beginning of the acquired encoded data and decodes the number of representative colors (the number of palettes) arranged at the beginning of the encoded data (step S502).

When the encoded data acquired by the acquiring unit 72 in step S501 are encoded data in which the number of representative colors is a fixed value, the process of step S502 is not performed.

Subsequently, the image decoding device 70 performs the decoding process in steps S503 to S506 in units used for the pixel block when the encoded data are obtained by encoding.

First, the index decoding unit 76 decodes an index of a pixel to be decoded (step S503). Subsequently, the representative color decoding unit 78 determines whether or not decoding of all the representative colors in the pixel block is completed (step S504). If the determination in step S504 is negative (step S504: No), the process proceeds to step S505.

In step S505, the representative color decoding unit 78 decodes the representative color associated with the index decoded in step S503 in the encoded data (step S505). The process then proceeds to step S506.

If, on the other hand, the determination in step S504 is positive (step S504: Yes), the process proceeds to step S506.

In step S506, the index decoding unit 76 determines whether or not the decoding process is terminated for all the pixels in the pixel block to be decoded (step S506). If the determination in step S506 is negative (step S506: No), the process returns to step S503 described above. If, on the other hand, the determination in step S506 is positive (step S506: Yes), this routine is terminated.

In the third and fourth embodiments, the case in which encoded data are read and decoding is performed din the order of an “index” and a “representative color” contained in the encoded data is described. The order of decoding may be in the order of a “representative color” and an “index”.

As described above, with the image decoding device 70 according to the present embodiment, encoded data generated in the second embodiment are decoded. Accordingly, the image decoding device 51 according to the present embodiment decodes encoded data obtained by arranging and encoding indices and representative colors identified by the indices alternately so that two or more representative colors are not successively arranged. The image decoding device 70 can thus start the decoding process before receiving all the representative colors contained in the encoded data.

With the image decoding device 70 according to the present embodiment, it is therefore possible to improve the throughput per unit time in decoding the encoded data.

Programs for performing each of the encoding process and the decoding process performed by the image encoding device 10, 10A, 40 and the image decoding device 51, 70 in the embodiments and the modifications described above are embedded in a ROM or the like and provided therefrom.

The programs for performing each of the encoding process and the decoding process performed by the image encoding device 10, 10A, 40 and the image decoding device 51, 70 in the embodiments and the modifications described above may be recorded on a computer readable storage medium such as a CD-ROM, a flexible disk (FD), a CD-R, and a DVD (digital versatile disk) in a form of a file that can be installed or executed, and provided therefrom.

Alternatively, the programs for performing each of the encoding process and the decoding process performed by the image encoding device 10, 10A, 40 and the image decoding device 51, 70 in the embodiments and the modifications described above may be stored on a computer system connected to a network such as the Internet, and provided by being downloaded via the network. Alternatively, the programs for performing each of the encoding process and the decoding process performed by the image encoding device 10, 10A, 40 and the image decoding device 51, 70 in the embodiments and the modifications described above may be provided or distributed through a network such as the Internet.

The programs for performing each of the encoding process and the decoding process performed by the image encoding device 10, 10A, 40 and the image decoding device 51, 70 in the embodiments and the modifications described above have a modular structure including the respective units described above. In an actual hardware configuration, a CPU (a processor) reads the programs from the ROM and executes the programs, whereby the respective units described above are loaded on a main storage device and generated on the main storage device. The units of the image encoding device 10, 10A, 40 and the image decoding device 51, 70 according to the embodiments and the modifications described above may be configured by hardware such as circuits.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image encoding device comprising:
a deciding unit configured to determine representative colors for expressing each of pixel blocks into which image data are divided;
an assigning unit configured to assign an index for identifying the representative color to each pixel in the pixel block; and
an encoding unit configured to encode indices and the representative colors, the indices and the representative colors in each pixel box being arranged alternately so that two representative colors are discontinuously encoded.

2. The image encoding device according to claim 1, wherein the encoding unit scans the indices assigned to pixels in the pixel block in a predetermined scan order, and encodes the representative colors and the indices, the representative colors being arranged in order of first appearances according to the scan order.

3. The image encoding device according to claim 1, wherein when the encoding unit scans the indices assigned to the pixels in the pixel block in a predetermined scan order, the encoding unit does not encode a representative color identified by an index having a same value as values for encoded indices.

4. The image encoding device according to claim 1, wherein the assigning unit assigns an index having a specific value to a pixel to be scanned first by the encoding unit in the pixel block.

5. The image encoding device according to claim 1, wherein the encoding unit further encodes the number of determined representative colors but does not encode the index if the number of representative color is one.

6. An image decoding device comprising:
an index decoding unit configured to decode indices for identifying representative colors for expressing a pixel block in encoded data obtained by alternately arranging and encoding the indices and the representative colors identified by the indices so that two representative colors are discontinuously encoded; and
a representative color decoding unit configured to decode the representative colors in the encoded data.

7. The image decoding device according to claim 6, wherein the encoded data is encoded for the representative colors in order of first appearances according to a predetermined scan order.

8. The image decoding device according to claim 6, wherein the encoded data is not encoded for the representative colors identified by the indices having same value as values for indices of the encoded representative colors.

9. The image decoding device according to claim 6, wherein the encoded data is further encoded for the number of determined representative colors except the number is one.

10. An image encoding method comprising:
determining representative colors for expressing each of pixel blocks into which image data are divided;
assigning an index for identifying the representative color to each pixel in the pixel block; and
encoding indices and the representative colors, the indices and the representative colors in each pixel box being arranged alternately so that two representative colors are discontinuously encoded.
